(19) United States
(12) Patent Application Publication
(10) Pub. No.: US 2026/0110287 A1
(43) Pub. Date: Apr. 23, 2026

(54) ROBOTIC APPLICATOR DEVICE AND METHOD FOR APPLYING A PROTECTOR TO A LEADING EDGE OF A WIND TURBINE BLADE

(71) Applicant: VESTAS WIND SYSTEMS A/S, Aarhus N (DK)

(72) Inventor: Hendrik Bareld BOOIJ, Struer (DK)

(21) Appl. No.: 19/116,863

(22) PCT Filed: Sep. 28, 2023
(86) PCT No.: PCT/DK2023/050231

§ 371 Date: Mar. 28, 2025

(30) Foreign Application Priority Data
Sep. 28, 2022 (DK) PA202270469

(51) Int. Cl. F03D 1/06; B25J 11/00; F03D 80/50

(52) U.S. Cl. CPC F03D 1/0675; B25J 11/0075; F03D 80/502; F05B 2230/90; F05B 2280/6011

(57) ABSTRACT

A robotic applicator device (40) for applying a protector (48) to a leading edge (30) of a wind turbine blade (20) includes a main frame (42), a drive (44) coupled to the main frame (42), and a plurality of stations (46) carried by the main frame (42) configured to apply the protector (48) to the leading edge (30) of the wind turbine blade (20). The stations (46) include a dispensing station (50) configured to hold and dispense a material (64) that forms the protector (48), an adhesive station (52) configured to apply adhesive (66) to an adherend surface (68) of the dispensed protector material (64) and/or the leading edge (30), an applicator station (54) configured to place the adherend surface (68) of the protector (48) onto the leading edge (30) of the wind turbine blade (20), and a curing station (56) configured to cure the adhesive (66) so as to bond the protector (48) to the leading edge (30). A method for applying the protector (48) to the leading edge (30) of the wind turbine blade (20) is also disclosed.

### TECHNICAL FIELD

The invention relates generally to wind turbines, and more particularly to robotic applicator devices and methods for applying a protector to a leading edge of a wind turbine blade.

### BACKGROUND

Wind turbines are used to produce electrical energy using a renewable resource and without combusting a fossil fuel. Generally, a wind turbine converts kinetic energy from the wind into electrical power. A conventional wind turbine installation includes a foundation, a tower supported by the foundation, and an energy generating unit positioned atop of the tower. The energy generating unit typically includes one or more nacelles to house several mechanical and electrical components, such as a generator, gearbox, and main bearing, and the wind turbine also includes a rotor operatively coupled to the components in the nacelle through a main shaft extending from the nacelle. Single rotor wind turbines and multi-rotor wind turbines (which may have multiple nacelles) are known, but for the sake of efficiency, the following description refers primarily to single rotor designs. The rotor, in turn, includes a central hub and a plurality of blades extending radially therefrom and is configured to interact with the wind to cause rotation of the rotor. The rotor is supported on the main shaft, which is either directly or indirectly operatively coupled with the generator which is housed inside the nacelle. Consequently, as wind forces the blades to rotate, electrical energy is produced by the generator. Wind power has seen significant growth over the last few decades, with many wind turbine installations being located both on land and offshore.

As noted above, blades interact with the wind to generate mechanical rotation of the rotor, which can then be converted into electrical energy. A wind turbine blade is a complex structure that must be constructed to withstand long-term service in an abusive environment, while also maximizing lift and minimizing drag forces. The blades move at varying speeds through the ambient environment surrounding the wind turbine, but often this movement is at high speed. Consequently, the blades will typically experience erosion and damage over time in operation as a result of friction from the air as well as potential impacts from rain, particulate matter, debris, or other items in the air, especially along the leading edge that is configured to face the direction of movement through the wind. The erosion or damage along the leading edge of the blade adversely affects the aerodynamic qualities of the blade over time, resulting in lower power production for given incoming wind speeds. Such erosion and damage on the blades can be corrected by routine maintenance and repair procedures.

One approach to minimize the erosion and damage to the leading edge of the blade is to apply a leading-edge protector during the blade manufacturing process. The leading-edge protector may be applied manually, but such an approach is time consuming and may induce voids, e.g., air bubbles, between the leading-edge protector and the leading edge. Moreover, because the leading-edge protector may be long and flexible and the adhesive curing time is long, it may be difficult to keep the leading-edge protector in its desired position along the leading edge while the adhesive cures. Also, because the leading-edge protector is being applied manually, a faster curing adhesive may not be utilized because a technician cannot work fast enough to apply the leading-edge protector with such fast-curing adhesive. In addition, it is difficult for a technician to apply adhesive to the leading-edge protector and pressure at the same time.

In view of the above, there is a desire for devices and methods for applying a leading-edge protector during the manufacture of a wind turbine blade that is simple, quick, and requires minimal equipment and few technicians.

### SUMMARY

To these and other ends, in one aspect of the invention a robotic applicator device for applying a protector to a leading edge of a wind turbine blade is disclosed. The device includes a main frame, a drive operatively coupled to the main frame and configured to move the main frame relative to the wind turbine blade, and a plurality of stations carried by the main frame for applying the protector to the leading edge of the wind turbine blade. The plurality of stations includes a dispensing station configured to hold and dispense a material that forms the leading-edge protector, an adhesive station configured to apply adhesive to an adherend surface of the dispensed protector material and/or the leading edge of the wind turbine blade, an applicator station configured to place the adherend surface of the leading-edge protector onto the leading edge of the wind turbine blade, and a curing station configured to cure the adhesive so as to bond the leading-edge protector to the leading edge of the wind turbine blade.

In one embodiment, the plurality of stations further comprises a cleaning station configured to clean the dispensed protector material.

In one embodiment, the dispensing station includes a transforming module, wherein the leading-edge protector is stored in the dispensing station in a coiled configuration, and wherein the transforming module is configured to transform the leading-edge protector from the coiled configuration to a straightened configuration.

In one embodiment, the applicator station includes a pressure module configured to apply a pressure to the leading-edge protector after the leading-edge protector has been placed onto the leading edge of the wind turbine blade.

In one embodiment, the curing station includes a heating module configured to heat the adhesive applied to the adherend surface of the leading-edge protector and/or to the leading edge of the wind turbine blade to thereby cure the adhesive.

In one embodiment, the plurality of stations further includes a sensing station configured to determine a topographic profile of at least a portion of the leading edge of the wind turbine blade. The sensing station may be operatively coupled to the applicator station and the applicator station may include a shaper module configured to conform the surface of the dispensed protector to the topographic profile of the at least the portion of the leading edge as detected by the sensing station.

In one embodiment, the dispensing station is configured to dispense a pre-formed leading-edge protector.

In one embodiment, the drive is supported by and movable along the wind turbine blade. In one embodiment, the drive is supported by and movable along a support surface disposed adjacent to the wind turbine blade.

In one embodiment, the main frame includes an upper frame panel with first and second opposed edges, a first side frame panel coupled to the first edge, and a second side frame panel coupled to the second edge. The main frame panel and the first and second side panels generally define a U-shaped cavity configured to receive at least part of the wind turbine blade therein.

In another aspect of the invention, a method for applying a protector to a leading edge of a wind turbine blade is disclosed. The method includes providing a robotic applicator device including a main frame and a dispensing station, an adhesive station, an applicator station, and a curing station, each station being carried by the main frame. The method further includes moving the robotic applicator device along the leading edge of the wind turbine blade, dispensing at the dispensing station a material that forms the leading-edge protector, applying adhesive at the adhesive station to an adherend surface of the dispensed protector material and/or the leading edge of the wind turbine blade, placing at the applicator station the adherend surface of the leading-edge protector onto the leading edge of the wind turbine blade, and curing at the curing station the adhesive so as to bond the leading-edge protector to the leading edge of the wind turbine blade.

In one embodiment, the main frame further carries a cleaning station, and the method further includes cleaning at the cleaning station the adherend surface of the dispensed protector material prior to applying the adhesive thereon.

In one embodiment, the dispensing station includes a transforming module, the leading-edge protector is stored in the dispensing station in a coiled configuration, and the method further includes transforming at the transforming module the leading-edge protector from the coiled configuration to a straightened configuration.

In one embodiment, the applicator station includes a pressure module and the method further includes applying at the pressure module pressure to the leading-edge protector after the leading-edge protector has been placed on the leading edge of the wind turbine blade.

In one embodiment, the step of curing the adhesive includes heating the adhesive.

In one embodiment, the main frame further carries a sensing station operatively coupled to the applicator station, the applicator station further includes a shaper module, and the method further includes determining at the sensing station a topographic profile of at least a portion of the leading edge of the wind turbine blade and conforming at the shaper module the surface of the dispensed leading-edge protector to the topographic profile of at least the portion of the leading edge.

In one embodiment, the method further includes supporting the robotic applicator device on the wind turbine blade as the robotic applicator device is moved along the leading edge of the wind turbine blade. In an alternative embodiment, the method further includes supporting the robotic applicator device on a support surface disposed adjacent the wind turbine blade as the robotic applicator device is moved along the leading edge of the wind turbine blade.

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is a perspective view of a wind turbine having a tower and an energy generating unit.

FIG. 2 is an elevation view of an exemplary wind turbine blade.

FIG. 3 is a schematic, elevation view of a robotic applicator device according to one embodiment of the invention.

FIG. 4 is a cross-sectional view of a wind turbine blade having a leading-edge protector

FIG. 5A is a schematic view illustrating the robotic applicator device of FIG. 3 being supported by the wind turbine blade.

FIG. 5B is a schematic view illustrating the robotic applicator device of FIG. 3 being supported by a support surface disposed adjacent to the wind turbine blade.

FIG. 6 is a flowchart showing the steps of a method for applying a protector to a leading edge of a wind turbine blade according to one embodiment of the invention.

FIG. 7 is a schematic view illustrating various steps of applying a protector to a leading edge of a wind turbine blade using the robotic applicator device of FIG. 3.

### DETAILED DESCRIPTION OF THE INVENTION

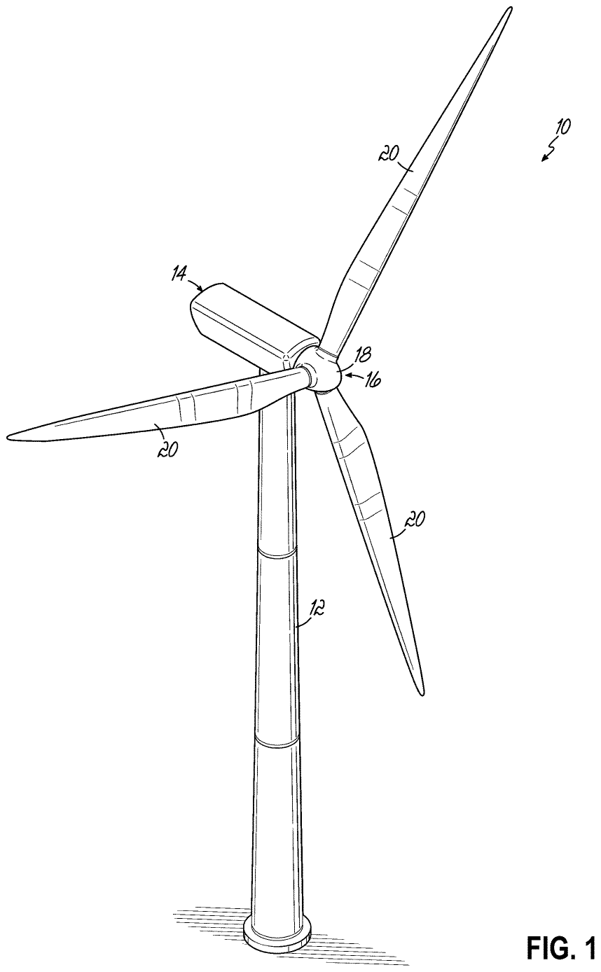

With reference to FIG. 1, a wind turbine 10 includes a tower 12, a nacelle 14 disposed at the apex of the tower 12, and a rotor 16 operatively coupled to a generator (not shown) via a gearbox (not shown) housed inside the nacelle 14. In addition to the generator and gearbox, the nacelle 14 may house various components needed to convert wind energy into electrical energy and to operate and optimize the performance of the wind turbine 10. The tower 12 supports the load presented by the nacelle 14, rotor 16, and other wind turbine components housed inside the nacelle 14 and operates to elevate the nacelle 14 and rotor 16 to a height above ground level or sea level, as may be the case, at which air currents having lower turbulence and higher velocity are typically found.

The rotor 16 may include a central hub 18 and a plurality of wind turbine blades 20 attached to the central hub 18 at locations distributed about the circumference of the central hub 18. In the representative embodiment, the rotor 16 includes three blades 20, however the number may vary. The blades 20, which project radially outward from the central hub 18, are configured to interact with passing air currents to produce rotational forces that cause the central hub 18 to spin about its longitudinal axis. The design, construction, and operation of the blades 20 are familiar to a person having ordinary skill in the art of wind turbine design and may include additional functional aspects to optimize performance. For example, pitch angle control of the blades 20 may be implemented by a pitch control mechanism (not shown) responsive to wind velocity to optimize power production in low wind conditions, and to feather the blades if wind velocity exceeds design limitations.

The rotor 16 may be coupled to the gearbox directly or indirectly via a main shaft (not shown) extending between the central hub 18 and the gearbox. The main shaft rotates with the rotor 16 and is supported within the nacelle 14 by a main bearing support (not shown) which supports the weight of the rotor 16 and transfers the loads on the rotor 16 to the tower 12. The gearbox transfers the rotation of the rotor 16 through a coupling to the generator. Wind exceeding a minimum level may activate the rotor 16, causing the rotor 16 to rotate in a direction substantially perpendicular to the wind, applying torque to the input shaft of the generator. The electrical power produced by the generator may be supplied to a power grid (not shown) or an energy storage system (not shown) for later release to the grid as understood by a person having ordinary skill in the art. In this way, the kinetic energy of the wind may be harnessed by the wind turbine 10 for power generation.

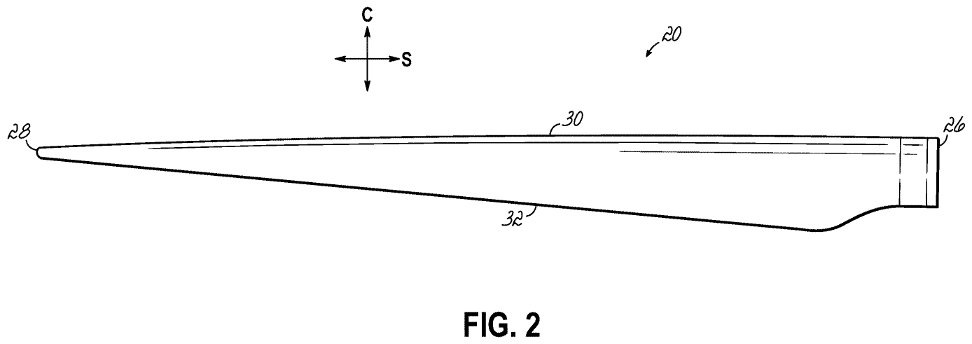

Referring to FIG. 2, the blade 20 includes a root end 26, a tip end 28, a leading edge 30, and a trailing edge 32. The blade 20 defines a spanwise direction S extending between the root end 26 and the tip end 28 and a chordwise direction C extending from the leading edge 30 and the trailing edge 32, where the spanwise direction S is generally orthogonal to the chordwise direction C. The leading edge 30 of the blade 20 includes a contoured surface. As can be appreciated, the contoured surface has a shape that may change along the leading edge 30 in the spanwise direction.

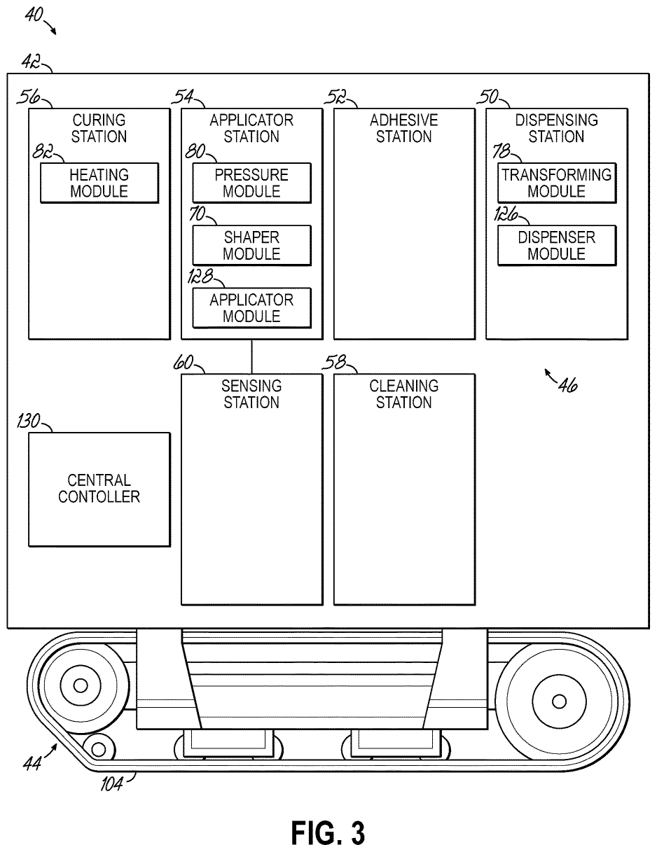

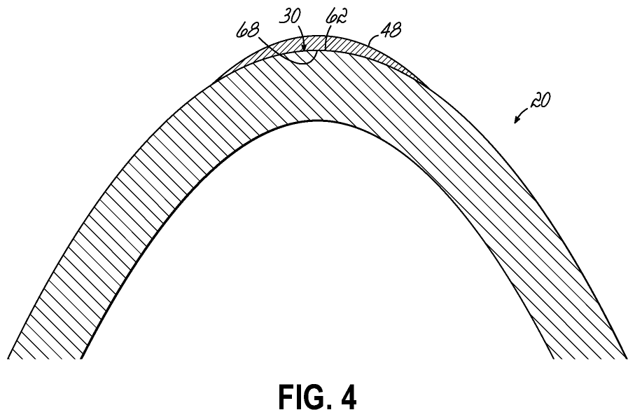

The invention contemplates a robotic applicator device for applying a protector to the leading edge 30 of the wind turbine blade 20. FIG. 3 illustrates a robotic applicator device 40 according to one embodiment of the invention. The robotic applicator device 40 includes a main frame 42 and a drive 44 operatively couple to the main frame 42. The drive 44 is configured to move the main frame 42 relative to the wind turbine blade 20. To that end, the drive 44 may include a propulsion system that may include a motor, a geartrain, a transmission, and a drive controller. The robotic applicator device 40 further includes a plurality of stations 46 all of which are carried by the main frame 42. As will explained in further detail below, the plurality of stations 46 cooperate to apply a protector 48 (FIG. 4) onto the leading edge 30 of the wind turbine blade 20. In one embodiment, the plurality of stations 46 may include a dispensing station 50, an adhesive station 52, an applicator station 54, and a curing station 56. The robotic applicator device 40 may be used to apply the leading-edge protector 48 during the manufacture of a wind turbine blade 20. Alternatively, the robotic applicator device 40 may be used during the repair of the leading edge 30 of the wind turbine blade 20. In the repair, the leading-edge protector 48 may be applied for the first time on the used wind turbine blade 20. In other words, the leading edge 30 may never have had a leading-edge protector until one is applied using the robotic applicator device 40. In another repair scenario, the wind turbine blade 20 may have had a leading-edge protector that has been damaged or degraded during use. In that case, the old leading-edge protector would have to be removed and then the robotic applicator device 40 may be used to apply another leading-edge protector 48 onto the leading edge 30 of the wind turbine blade 20.

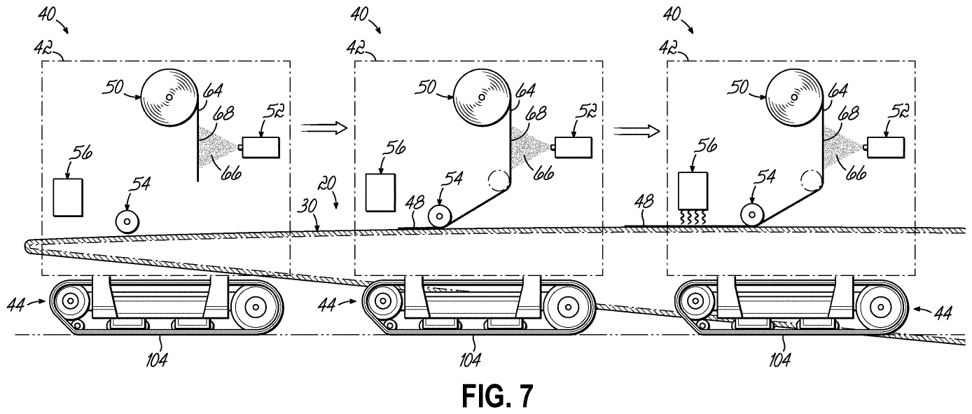

The dispensing station 50 is configured to hold and dispense a material 64 (FIG. 7) that forms the leading-edge protector 48. The material 64 may be a polymer material, such as a polyether-based polyurethane, for example. The adhesive station 52 is configured to apply adhesive 66 (FIG. 7) to an adherend surface 68 (FIG. 7) of the dispensed protector material 64 and/or the leading edge 30 of the wind turbine blade 20. To that end, the adhesive station 52 may include various components to apply the adhesive 66 including sprayers, applicators, misters, brushes, and other types of adhesive dispensers. The adhesive station 52 may further include a holding tank or other storage container for the adhesive 66 and a pump for removing the adhesive 66 from the holding tank. The applicator station 54 is configured to place the adherend surface 68 of the leading-edge protector 48 onto the leading edge 30 of the wind turbine blade 20. To that end, the applicator station 54 may include guides, rollers, rails, chutes, or other positioning mechanisms to assist with placing the adherend surface 68 in the correct location on the leading edge 30 of the wind turbine blade 20. The curing station 56 is configured to cure the adhesive 66 so as to bond the leading-edge protector 48 to the leading edge of the wind turbine blade 20.

In one embodiment, the plurality of stations 46 may further include a cleaning station 58 which is configured to clean the dispensed protector material 64 before the adhesive 66 is applied the adherend surface 68 of the dispensed protector material 64. The cleaning station may include a supply of cleaning fluid/agent/detergent, a pump, a sprayer, and brushes or scrubbers configured to clean the adherend surface 68 before the adhesive 66 is applied.

In one embodiment, the plurality of stations 46 may further include a sensing station 60 which is configured to determine a topographic profile 62 (FIG. 4) of at least a portion of the leading edge 30 of the wind turbine blade 20. The sensing station 60 may include a vision system for determining the topographic profile 62. The vision system may include one or more cameras, ultrasonic transducers, or lasers to interrogate the leading edge 30 to determine the topographic profile 62. The vision system may also include a digital processor using know algorithms to create a digital representation of the topographic profile 62. The sensing station 60 may be operatively coupled to the applicator station 54. In that regard, the applicator station 54 may include a shaper module 70 which is configured to conform the adherend surface 68 (FIG. 4) of the dispensed protector material 64 to the topographic profile 62 of at least the portion of the leading edge 30 as detected by the sensing station 60. The shaper module 70 may include one more deformable mandrels or positive moulds that may be used to conform the adherend surface 68 to the topographic profile 62. The shaper module 70 may further include a heater to heat the adherend surface 68 to facilitate the conformation process. The digital processor may be operatively connected to the shaper module 70 such that the digital representation of the topographic profile 62 may be relayed to the shaper module 70 so the deformable mandrel, for example, may be actively manipulated to match the shape of the topographic profile 62 of the leading edge 30. The process for conforming the adherend surface 68 to match the topographic profile 62 may be continuous or intermittent.

In one embodiment, the leading-edge protector 48 may be a pre-formed protector which is stored in a coiled configuration in the dispensing station 50 on a coil or spool. As such, the dispensing station may include a transforming module 78 which is configured to transform the pre-formed leading-edge protector 48 from the coiled configuration to a straightened configuration. The coiled pre-formed leading-edge protector 48 may take a curved/arcuate set as a result of being stored in the coiled configuration. In other words, when the coiled leading-edge protector 48 is rolled off the storage reel, for example, the leading-edge protector 48 may still have a noticeable curve to it similar to how it was curved in the coiled configuration. The transforming module 78 helps to eliminate or greatly minimize the curved/arcuate set so that the leading-edge protector 48 is in a generally straightened condition after it is dispensed and prior to it being placed onto the leading edge 30 of the wind turbine blade 20. To that end, the transforming module 78 may include rollers, presses, plates, or heaters to assist with minimizing the curved/arcuate set. In another embodiment, the leading-edge protector 48 may be stored in the robotic applicator device 40 as pre-formed leading-edge protector 48 in a linear form, such as in the form of strips of predetermined lengths, such that the transforming module 78 is not needed.

In one embodiment, the dispensing station 50 may include a pressure module 80 which is configured to apply a pressure to the leading-edge protector 48 after the leading-edge protector 48 has been placed onto the leading edge 30 of the wind turbine blade 20. The pressure module 80 assists with bonding the adherend surface 68 of the leading-edge protector 48 with the adhesive 66 to the leading edge 30 of the wind turbine blade 20. The pressure module 80 assists in eliminating or minimizing voids or air bubbles between the adherend surface 68 of the leading-edge protector 48 and the leading edge 30 of the wind turbine blade 20. To that end, the pressure module 80 may include rollers, pads, inflatable bladders, pressure plates, or other suitable devices to apply pressure to the leading-edge protector 48.

In one embodiment, the curing station 56 may include a heating module 82 which is configured to heat the adhesive 66 applied to the adherend surface 68 of the leading-edge protector 48 and/or to the leading edge 30 of the wind turbine blade 20 so as to cure the adhesive 66 thereon. The heating module 82 may include resistive heaters, IR light or UV light or any other suitable device for generating heat to cure the adhesive.

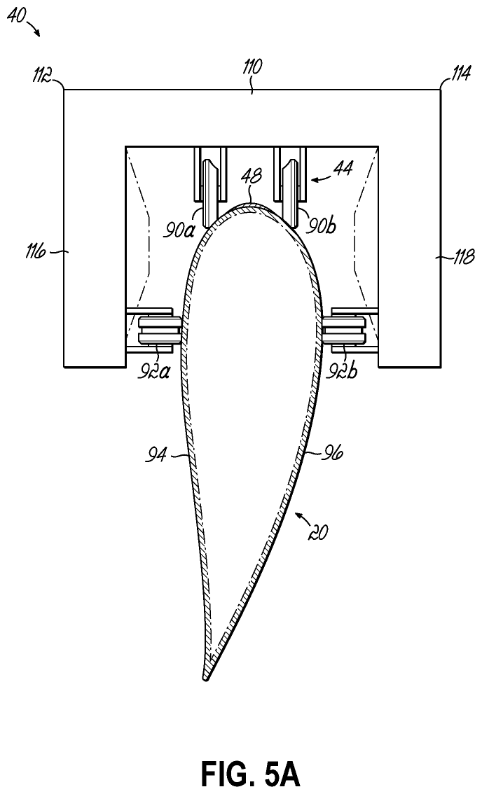

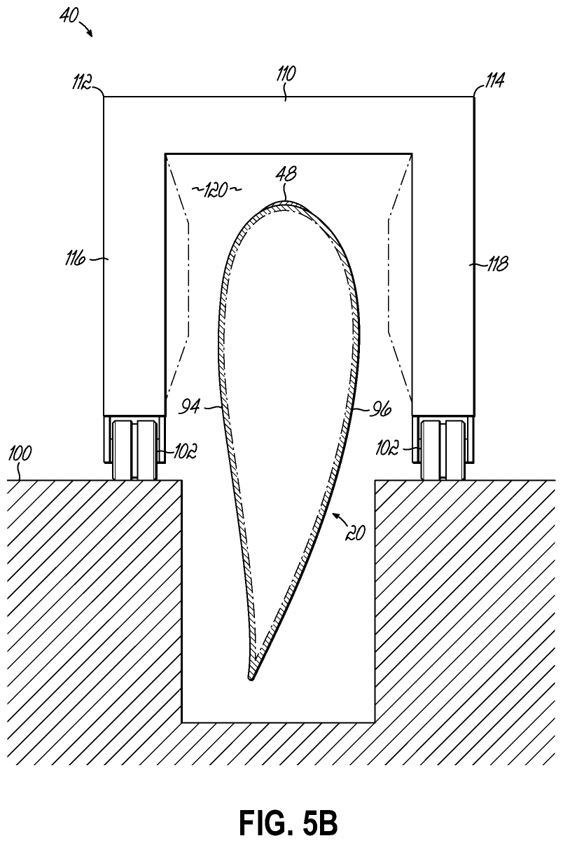

In one embodiment, the drive 44 may be supported by and movable along the wind turbine blade as illustrated in FIG. 5A. In this embodiment, the drive 44 may include spaced apart drive wheels 90a, 90b that contact wind turbine blade 20 on either side of the leading edge 30 so as to not contact or interfere with the leading-edge protector 48 placed upon the leading edge 30. The drive 44 may also include guide wheels 92a, 92b that contact opposing sides 94, 96 of the wind turbine blade 20. The guide wheels 92a, 92b are configured to guide the motion of the robotic applicator device 40 as it moves along the wind turbine blade 20. While drive wheels 90a, 90b are illustrated as the means of moving the robotic applicator device 40, in alternative embodiments, the drive 44 may be include a moving track, a rack and pinion drive, a chain, a ski, movable legs, and/or other types of drives.

In another embodiment, the drive 44 may be supported by and movable along a support surface 100 disposed adjacent to the wind turbine blade 20 as illustrated in FIG. 5B. In this embodiment, the drive 44 may include wheels 102 (FIG. 5B) or tracks 104 (FIG. 5B) to move the robotic applicator device 40 relative to the wind turbine blade 20. The drive 44 may use other drive mechanisms besides wheels 102 and tracks 104 to move the robotic applicator device 40 along the support surface 100.

In one embodiment and with continued reference to FIGS. 5A and 5B, the main frame 42 may include an upper frame panel 110 having first and second opposed edges 112, 114, a first side frame panel 116 coupled to the first edge 112, and a second side frame panel 118 coupled to the second edge 114. The upper frame panel 110 and the first and second side panels 116, 118 may generally define a U-shaped cavity 120 configured to receive at least part of the wind turbine blade 20 therein. The main frame 42 may have different structural features and other configurations beyond the frame panels 110, 116, 118 and U-shaped cavity 120 discussed and illustrated in FIGS. 5A and 5B.

As mentioned above the leading-edge protector 48 may be a pre-formed protector which is stored in a coiled configuration in the dispensing station 50. In another embodiment, the dispensing station 50 may include a dispenser module 126 where the dispensed protector material 64 is flowable to form the leading-edge protector 48. To that end, the dispenser module 126 will dispense the flowable protector material 64 and an applicator module 128 in the applicator station 54 will shape the flowable protector material 64 into a predetermined profile for the leading-edge profile 48 as the flowable protector material 64 is applied to leading edge 30 of the wind turbine blade 20. In this embodiment, the dispensing station 50 may include a liquid holding tank or other suitable container for holding the flowable protector material 64. The dispensing station 50 may also include a pump to move the flowable protector material 64 from the holding tank to the dispenser module 126.

The robotic applicator device 40 may include a central controller 130 which may be operatively couple to all or some of the various stations and modules discussed above. The central controller is configured to manage the various stations and modules as the robotic applicator device 40 moves along the leading edge 30 to apply the leading-edge protector 48. The central controller 130 may be include a wireless receiver so that a technician may wirelessly communicate with the central controller 130 as the robotic applicator device 40 is operational.

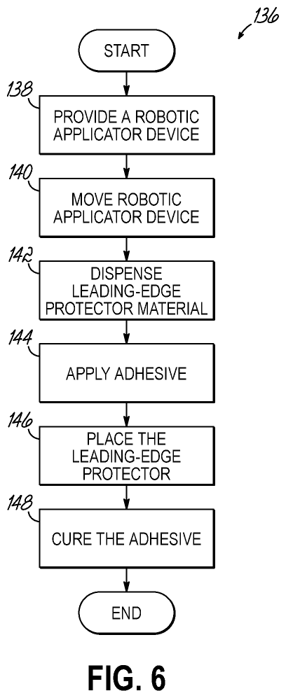

The invention further contemplates a method for applying the protector 48 to the leading edge 30 of the wind turbine blade 20. Referring to FIGS. 6 and 7, a method 136 for applying the protector 48 to the leading edge 30 according to one aspect of the invention is illustrated. Exemplary steps of the method 136 are outlined in the flowchart of FIG. 6 and those steps are schematically illustrated in FIG. 7. The first step 138 of the method 136 is providing the robotic applicator device 40 which includes the main frame 42, the dispensing station 50, the adhesive station 52, the applicator station 54, and the curing station 56. Each station 50, 52, 54, 56 is carried by the main frame 42. The second step 140 of the method 136 includes moving the robotic applicator device 40 along the leading edge 30 of the wind turbine blade 20. The third step 142 of the method 136 includes dispensing at the dispensing station 50 the protector material 64 that forms the leading-edge protector 48. The fourth step 144 of the method 136 includes applying adhesive 66 at the adhesive station 52 to the adherend surface 68 of the dispensed protector material 64 and/or the leading edge 30 of the wind turbine blade 20. The fifth step 146 of the method 136 includes placing at the applicator station 54 the adherend surface 68 of the leading-edge protector 48 onto the leading edge 30 of the wind turbine blade 20. The sixth step 148 of the method 136 includes curing at the curing station 56 the adhesive 66 so as to bond the leading-edge protector 48 to the leading edge 30 of the wind turbine blade 20.

In one embodiment of the method 136, the main frame 42 further carries a cleaning station 58 and the method 136 may further include cleaning at the cleaning station 58 the adherend surface 68 of the dispensed protector material 64 prior to applying the adhesive 66 thereon.

In one embodiment of the method 136, the dispensing station 50 may include the transforming module 78 and the leading-edge protector 48 may be stored in the dispensing station 50 in a coiled configuration. The method 136 may further include transforming at the transforming module 78 the leading-edge protector 48 from the coiled configuration to a straightened configuration.

In one embodiment of the method 136, the applicator station 54 may include a pressure module 80 and the method 136 may further include applying at the pressure module 80 pressure to the leading-edge protector 48 after leading-edge protector 48 has been placed on the leading edge 30 of the wind turbine blade 20.

In one embodiment of the method 136, the step 148 of curing the adhesive includes heating the adhesive 66.

In one embodiment of the method 136, the main frame further carries a sensing station 60 operatively coupled to the applicator station 54 and the applicator station 54 further includes a shaper module 70. The method 136 further includes determining at the sensing station 60 the topographic profile 62 of at least a portion of the leading edge 30 of the wind turbine blade 20 and conforming at the shaper module 70 the adherend surface 68 of the dispensed leading-edge protector 48 to the topographic profile 62 of at least the portion of the leading edge 30.

In one embodiment, the method 136 may further include supporting the robotic applicator device 40 on the wind turbine blade 20 as the robotic applicator device 40 is moved along the leading edge 30 of the wind turbine blade 20. In an alternative embodiment, the method 136 may further include supporting the robotic applicator device 40 on the support surface 100 disposed adjacent the wind turbine blade 20 as the robotic applicator device 40 is moved along the leading edge 30 of the wind turbine blade 20.

FIG. 7 schematically illustrates steps 138, 140, 142, 144, 146, 148 of method 136. On the left side of FIG. 7, the robotic applicator device 40 is provided. In addition, the drive 44 is moving the robotic applicator device 40 along the leading edge 30 of the wind turbine blade 20. The protector material 64 that forms the leading-edge protector 48 is being dispensed from the dispensing station 50. In addition, the adhesive station 52 is applying adhesive 66 to the adherend surface 68 of the dispensed protector material 64. In the middle of FIG. 7, the robotic applicator device 40 has moved further down the leading edge 30 of the wind turbine blade 20. Also, the applicator station 54 is placing the adherend surface 68 of the leading-edge protector 48 onto the leading edge 30 of the wind turbine blade 20. In the right side of FIG. 7, the curing station 56 is curing, such as by applying heat, for example, the adhesive 66 so as to bond the leading-edge protector 48 to the leading edge 30 of the wind turbine blade 20. In one embodiment, the heating station 56 provides a section of controlled environment, such as limited humidity and/or limited temperature variation to allow a self-curing adhesive to cure without specifically activating the adhesive.

Advantageously, all of the stations 50, 52, 54, 56, are carried by the main frame 42. That is, all the necessary devices and leading edge material needed to apply the leading-edge protector 48 onto the leading edge 30 of the blade 20 is carried by the main frame 42. Consequently, the robotic applicator device 40 is a self-contained device that is capable of applying the leading-edge protector 48 without requiring external devices to apply the leading-edge protector 48. As discussed above, the robotic applicator device 40 may also include the cleaning station 58 and the sensing station 60 for the purposes described above.

While the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A robotic applicator device for applying a protector to a leading edge of a wind turbine blade, comprising:
a main frame;
a drive operatively coupled to the main frame and configured to move the main frame relative to the wind turbine blade; and
a plurality of stations carried by the main frame for applying the protector to the leading edge of the wind turbine blade, the plurality of stations comprising:
a dispensing station configured to hold and dispense a material that forms the leading-edge protector;
an adhesive station configured to apply adhesive to an adherend surface of the dispensed protector material and/or the leading edge of the wind turbine blade;
an applicator station configured to place the adherend surface of the dispensed protector material onto the leading edge of the wind turbine blade and
a curing station configured to cure the adhesive so as to bond the leading-edge protector to the leading edge of the wind turbine blade.

2. The robotic applicator device of claim 1, wherein the plurality of stations further comprises a cleaning station configured to clean the dispensed protector material

3. The robotic applicator device of claim 1 or 2, wherein the dispensing station includes a transforming module wherein the leading-edge protector is stored in the dispensing station in a coiled configuration, and wherein the transforming module is configured to transform the leading-edge protector from the coiled configuration to a straightened configuration.

4. The robotic applicator device of claim 3, wherein the applicator station includes a pressure module configured to apply a pressure to the leading-edge protector after the leading-edge protector has been placed onto the leading edge of the wind turbine blade.

5. The robotic applicator device of claim 4, wherein the curing station includes a heating module configured to heat the adhesive applied to the adherend surface of the dispensed protector material and/or to the leading edge of the wind turbine blade to thereby cure the adhesive

6. The robotic applicator device of claim 5, wherein the plurality of stations further comprises a sensing station configured to determine a topographic profile of at least a portion of the leading edge of the wind turbine blade.

7. The robotic applicator device of claim 6, wherein the sensing station is operatively coupled to the applicator station, and wherein the applicator station includes a shaper module configured to conform the adherend surface of the dispensed protector material to the topographic profile of the at least the portion of the leading edge as detected by the sensing station.

8. The robotic applicator device of claim 1, wherein the dispensing station is configured to dispense a pre-formed leading-edge protector.

9. The robotic applicator device of claim 8, wherein the drive is supported by and movable along the wind turbine blade

10. The robotic applicator device of claim 8, wherein the drive is supported by and movable along a support surface disposed adjacent to the wind turbine blade.

11. The robotic applicator device of claim 10, wherein the main frame includes an upper frame panel with first and second opposed edges a first side frame panel coupled to the first edge, and a second side frame panel coupled to the second edge, the upper frame panel and the first and second side frame panels defining a U-shaped cavity configured to receive at least part of the wind turbine blade therein.

12. A method for applying a protector to a leading edge of a wind turbine blade, comprising:
providing a robotic applicator device including a main frame and a dispensing station, an adhesive station, an applicator station and a curing station, each station being carried by the main frame;
moving the robotic applicator device along the leading edge of the wind turbine blade;
dispensing at the dispensing station a material that forms the leading-edge protector;
applying adhesive at the adhesive station to an adherend surface of the dispensed protector material and/or the leading edge of the wind turbine blade;
placing at the applicator station the adherend surface of the dispensed protector material onto the leading edge of the wind turbine blade; and
curing at the curing station the adhesive so as to bond the leading-edge protector to the leading edge of the wind turbine blade

13. The method of claim 12, wherein the main frame further carries a cleaning station, and wherein the method further comprises:
cleaning at the cleaning station the adherend surface of the dispensed protector material prior to applying the adhesive thereon.

14. The method of claim 12, wherein the dispensing station includes a transforming module and wherein the leading-edge protector is stored in the dispensing station in a coiled configuration, and wherein the method further comprises:
transforming at the transforming module the leading-edge protector from the coiled configuration to a straightened configuration.

15. The method of claim 14 , wherein the applicator station includes a pressure module, and wherein the method further comprises:
applying at the pressure module pressure to the leading-edge protector after leading-edge protector has been placed on the leading edge of the wind turbine blade.

16. The method of claim 15, wherein the step of curing the adhesive includes heating the adhesive.

17. The method of claim 16 , wherein the main frame further carries a sensing station operatively coupled to the applicator station wherein the applicator station further includes a shaper module, and wherein the method further comprises:
determining at the sensing station a topographic profile of at least a portion of the leading edge of the wind turbine blade; and
conforming at the shaper module the adherend surface of the dispensed protector material to the topographic profile of at least the portion of the leading edge.

18. The method of claim 17, further comprising:
supporting the robotic applicator device on the wind turbine blade as the robotic applicator device is moved along the leading edge of the wind turbine blade.

19. The method of claim 17, further comprising:
supporting the robotic applicator device on a support surface disposed adjacent the wind turbine blade as the robotic applicator device is moved along the leading edge of the wind turbine blade
